(19) United States
(12) Patent Application Publication
(10) Pub. No.: US 2025/0200247 A1
(43) Pub. Date: Jun. 19, 2025

(54) INFORMATION PROCESSING APPARATUS, INFORMATION PROCESSING METHOD, AND STORAGE MEDIUM

(71) Applicant: Tokyo Electron Limited, Tokyo (JP)

(72) Inventor: Hirokazu KYOKANE, Yamanashi (JP)

(21) Appl. No.: 18/975,429

(22) Filed: Dec. 10, 2024

(30) Foreign Application Priority Data
Dec. 13, 2023 (JP) 2023-210067

(51) Int. Cl. G06F 30/20

(52) U.S. Cl. CPC G06F 30/20

(57) ABSTRACT

An information processing apparatus includes a model acquisition unit configured to acquire a mathematical model corresponding to a process result obtained by a substrate processing apparatus; a data acquisition unit configured to acquire measurement data indicating the process result measured using the substrate processing apparatus; a fitting unit configured to fit a parameter of the mathematical model based on the measurement data; and a prediction unit configured to predict the process result based on the mathematical model with the parameter fitted by the fitting unit.

### CROSS-REFERENCE TO RELATED APPLICATIONS

This application is based on and claims priority from Japanese Patent Application No. 2023-210067 filed on Dec. 13, 2023 with the Japan Patent Office, the disclosure of which is incorporated herein its entirety by reference.

### TECHNICAL FIELD

The present disclosure relates to an information processing apparatus, an information processing method, and a storage medium.

### BACKGROUND

There are known technologies for predicting a process result obtained by a substrate processing apparatus, thereby optimizing process conditions for the substrate processing apparatus. Japanese Patent Application Laid-Open No. 2022-119321 discloses an information processing apparatus that generates a machine learning model of a semiconductor manufacturing apparatus performing a processing according to process conditions, and that searches for process conditions capable of achieving a target process result using the machine learning model.

### SUMMARY

According to one aspect of the present disclosure, there is provided an information processing apparatus including a model acquisition unit configured to acquire a mathematical model corresponding to a process result obtained by a substrate processing apparatus; a data acquisition unit configured to acquire measurement data indicating the process result measured using the substrate processing apparatus; a fitting unit configured to fit a parameter of the mathematical model based on the measurement data; and a prediction unit configured to predict the process result based on the mathematical model with the parameter fitted by the fitting unit.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram illustrating an overall configuration of a substrate processing system.

FIG. 2 is a schematic cross-sectional view illustrating a substrate processing apparatus.

FIG. 3 is a block diagram illustrating a hardware configuration of a computer.

FIG. 4 is a block diagram illustrating a functional configuration of an optimization device.

FIG. 5 is a diagram illustrating an example of an experiment plan according to a conventional art.

FIG. 6 is a diagram illustrating an example of an experiment plan according to a conventional art.

FIG. 7 is a diagram illustrating an example of an experiment plan according to an embodiment of the present disclosure.

FIG. 8 is a diagram illustrating an example of an experiment plan according to an embodiment of the present disclosure.

FIG. 9 is a flowchart illustrating a modeling process.

FIG. 10 is a flowchart illustrating an optimization process.

FIG. 11 is a diagram illustrating an optimization support tool.

FIG. 12 is a diagram illustrating prediction accuracy according to a conventional art.

FIG. 13 is a diagram illustrating prediction accuracy according to an embodiment of the present disclosure.

### DETAILED DESCRIPTION

In the following detailed description, reference is made to the accompanying drawings, which form a part thereof. The illustrative embodiments described in the detailed description, drawings, and claims are not meant to be limiting. Other embodiments may be utilized, and other changes may be made without departing from the spirit or scope of the subject matter presented here.

Hereinafter, embodiments of the present disclosure will be described with reference to the drawings. In the respective drawings, the same components may be denoted by the same reference numerals, and overlapping descriptions thereof may be omitted.

### Embodiments

An embodiment of the present disclosure relates to a substrate processing system including a substrate processing apparatus that processes a substrate, which is a processing target. In the present embodiment, the substrate processing system includes an optimization device that optimizes process conditions based on a process result obtained by the substrate processing apparatus.

The substrate processing apparatus performs a predetermined process according to process conditions. The process conditions are optimized to obtain a good process result by the substrate processing apparatus. The optimization of the process conditions may be frequently performed by an expert well-informed of the substrate processing apparatus or a process, based on the expert's knowledge. In addition, the optimization of the process conditions may be performed based on machine learning. In the optimization of the process conditions based on machine learning, process conditions for obtaining a prediction result satisfying a target are searched, by predicting a process result using, for example, a regression method.

In the optimization by an expert, man-hours required to find process conditions for obtaining a prediction result satisfying a target are different depending on the expert's experience. In addition, since the optimization by the expert highly depends on individuals, it is difficult to optimize process conditions in environments where there is no optimal expert.

In the optimization by machine learning, since the accuracy of a regression model highly depends on the number of experiments, a large number of experiments are required to ensure a sufficient accuracy. For example, in linear regression, when the number of experiments is insufficient, a physical phenomenon occurring during a process may not be reproduced with high accuracy. In addition, for example, in nonlinear regression, since the prediction accuracy of extrapolation is low, it is necessary to repeat experiments over a wide range. In general, since a regression model has low robustness, it is difficult to use the regression model for general purposes. The low robustness means, for example, properties such as being unable to respond to changes over time in a device or being unable to be used in different devices.

In the present embodiment, the process result is predicted using a model suitable for the physical phenomenon occurring during the process. In the present embodiment, parameters of the model are fitted based on data measured from the process result by the substrate processing apparatus.

In one aspect, according to the present embodiment, since a physical phenomenon occurring during the process may be reproduced with high accuracy, the process result may be predicted with high accuracy. According to the present embodiment, a model may be generated with a small number of experiments, so that process result may be predicted efficiently. Furthermore, according to the present embodiment, even without an expert well-informed of the device or process, the process conditions may be optimized in a short period of time. As a result, the lead time for process development is significantly shortened.

### <System Configuration>

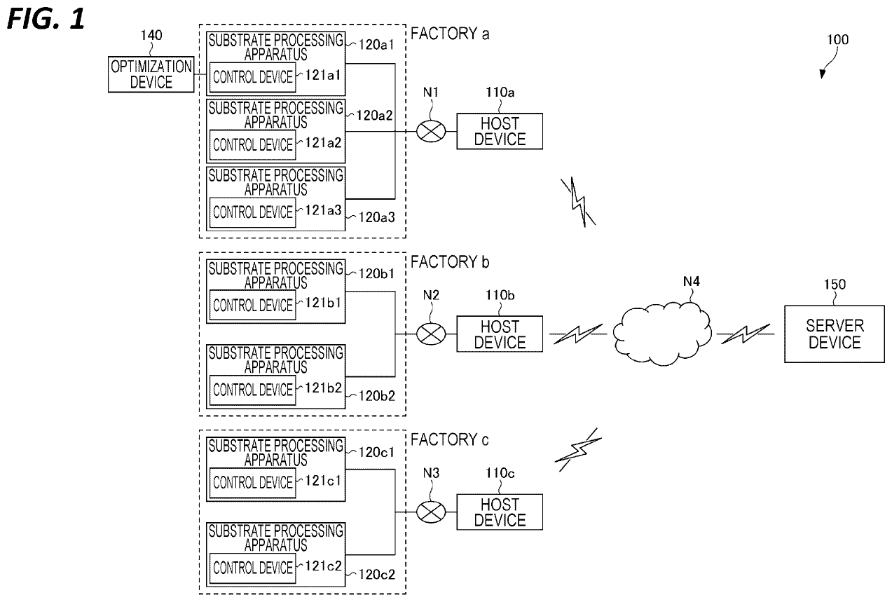

An overall configuration of the substrate processing system in the present embodiment will be described with reference to FIG. 1. FIG. 1 is a block diagram illustrating the overall configuration of the substrate processing system.

As illustrated in FIG. 1, a substrate processing system 100 includes substrate processing apparatuses 120a1 to 120a3 and control devices 121al to 121a3 in a factory a. The substrate processing apparatuses 120al to 120a3 and the control devices 121al to 121a3 are connected by a wired or wireless connection.

In addition, the substrate processing system 100 includes substrate processing apparatuses 120b1 and 120b2 and control devices 121b1 and 121b2 in a factory b. The substrate processing apparatuses 120b1 and 120b2 and the control devices 121b1 and 121b2 are connected by a wired or wireless connection.

Furthermore, the substrate processing system 100 includes substrate processing apparatuses 120c1 and 120c2 and control devices 121c1 and 121c2 in a factory c. The substrate processing apparatuses 120c1 and 120c2 and the control devices 121cl and 121c2 are connected by a wired or wireless connection.

The substrate processing apparatuses 120a1 to 120a3, the substrate processing apparatuses 120b1 and 120b2, and the substrate processing apparatuses 121c1 and 121c2 are connected to host devices 110a, 110b, and 110c, respectively, via networks N1 to N3. Under the control of each control device based on instructions from the host devices 110a, 110b, and 110c, each substrate processing apparatus performs a substrate processing. The host devices 110a, 110b, and 110c are connected to a server device 150 via a network N4, such as the Internet.

In the following description, the substrate processing apparatuses 120al to 120a3, 120b1, 120b2, 120c1, and 120c2 are also collectively referred to as a substrate processing apparatus 120. In addition, the control devices 121a1 to 121a3, 121b1, 121b2, 121cl, and 121c2 are also collectively referred to as a control device 121. The host devices 110a, 110b, and 110c are also collectively referred to as a host device 110.

The substrate processing apparatuses 120a1 to 120a3, the substrate processing apparatuses 120b1 and 120b2, and the substrate processing apparatuses 120c1 and 120c2 store in their own apparatuses a wide range of data that they each manage.

An optimization device 140 is connected to the substrate processing apparatus 120 including the substrate processing apparatus 120a1, and continuously acquires data accumulated in each substrate processing apparatus 120. The example in FIG. 1 illustrates a state where the optimization device 140 is connected to the substrate processing apparatus 120a1, but the present disclosure is not limited thereto. Hereinafter, the details of a case where the optimization device 140 is connected to the substrate processing apparatus 120al will be described in the present embodiment.

The substrate processing system 100 illustrated in FIG. 1 is provided by way of example, and examples of various system configurations may be provided depending on usage or purposes. The classification of apparatuses such as the host device 110, the substrate processing apparatus 120, the control device 121, the optimization device 140, and the server device 150 illustrated in FIG. 1 is provided by way of example. For example, the number of factories, the number of host devices 110, the number of substrate processing apparatuses 120, the number of control devices 121, and the number of optimization devices 140 are provided by way of example and are not limited thereto.

For example, the substrate processing system 100 may have various configurations such as a configuration in which at least two of the host device 110, the substrate processing apparatus 120, the control device 121, the optimization device 140, and the server device 150 are integrated or they are further separated. For example, the control device 121 may control a plurality of substrate processing apparatuses 120 in an integrated manner, or a single control device may be provided for each substrate processing apparatus 120 or may be integrated with the substrate processing apparatus 120.

The optimization device 140 may be implemented by the host device 110, or may be implemented by the server device 150. In this case, the optimization device 140 is unnecessary. In addition, the optimization device 140 may be implemented by the control device 121. The optimization device 140 may be implemented by a control device (not illustrated) that controls a plurality of control devices 121 in an integrated manner.

### <Substrate Processing Apparatus>

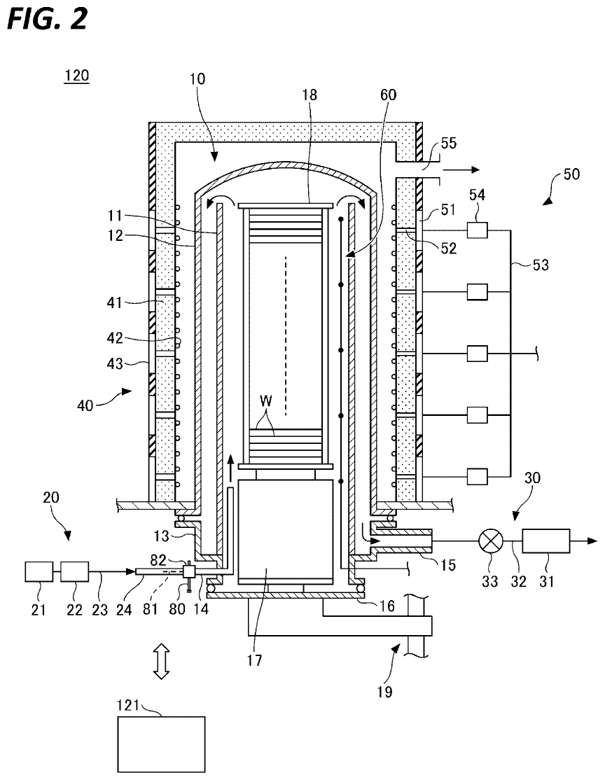

An example of a substrate processing apparatus in the present embodiment will be described with reference to FIG. 2. FIG. 2 is a schematic cross-sectional view illustrating a vertical-type heat treatment apparatus, which is an example of the substrate processing apparatus in the present embodiment.

A vertical-type heat treatment apparatus 120 in the present embodiment is a substrate processing apparatus that accommodates a plurality of semiconductor wafers W, which are an example of processing targets, at once and performs heat treatment thereon, such as oxidation, diffusion, or low-pressure chemical vapor deposition (CVD). As illustrated in FIG. 2, the vertical-type heat treatment apparatus 120 includes a processing container 10, a gas supply unit 20, an exhaust port 30, a heating unit 40, a cooling unit 50, and the control device 121.

The processing container 10 has an approximately cylindrical shape. The processing container 10 includes an inner tube 11, an outer tube 12, a manifold 13, an injector 14, a gas outlet 15, and a cover 16. The inner tube 11 has an approximately cylindrical shape. The outer tube 12 has an approximately cylindrical shape with a ceiling and forms a double-tube structure by the inner tube 11 and the outer tube 12. The inner tube 11 and the outer tube 12 are formed of a heat-resistant material, such as quartz, for example.

The manifold 13 has an approximately cylindrical shape. The manifold 13 supports lower ends of the inner tube 11 and the outer tube 12. The manifold 13 is formed of stainless steel, for example. The injector 14 penetrates the manifold 13 and extends horizontally within the inner tube 11, and bends in an L-shape and extends upwardly within the inner tube 11. The injector 14 has a base end connected to a gas introduction pipe 24 and an open front end. The injector 14 ejects a processing gas (hereinafter, simply referred to as “gas”) introduced through the gas introduction pipe 24 into the inner tube 11 from an opening at the front end. One or more injectors 14 may be provided.

The gas outlet 15 is formed in the manifold 13. The processing gas is exhausted by the exhaust port 30 through the gas outlet 15. The cover 16 hermetically seals an opening at a bottom of the manifold 13. The cover 16 is formed of, for example, stainless steel. On the cover 16, a wafer boat (substrate holding mechanism) 18 is disposed via a heat insulation tank 17. The heat insulation tank 17 and the wafer boat 18 are formed of a heat-resistant material such as, for example, quartz.

The wafer boat 18 holds a plurality of semiconductor wafers W approximately horizontally with predetermined intervals in a vertical direction. A lifting mechanism 19 raises the cover 16, so that the wafer boat 18 is carried (loaded) into the processing container 10 and accommodated within the processing container 10. The lifting mechanism 19 lowers the cover 16, so that the wafer boat 18 is carried out (unloaded) from the processing container 10.

The gas supply unit 20 includes a gas source 21, an integrated gas system (IGS) 22, an external pipe 23, and the gas introduction pipe 24. The gas source 21 is a source of processing gases and includes, for example, a film formation gas source, a cleaning gas source, and a purge gas source. The IGS 22 is an integrated circuit of gas pipes and includes a group of pipes connected to the film formation gas source, the cleaning gas source, and the purge gas source, respectively. A flow control unit is installed in the IGS 22 to control a flow of a gas through each pipe. The flow control unit includes, for example, a mass flow controller, and an opening/closing valve.

The IGS 22 is connected to the external pipe 23. The external pipe 23 is connected to the gas introduction pipe 24. A heater (not illustrated) is wound around an outer circumference of the external pipe 23 to heat the external pipe 23. The gas introduction pipe 24 is connected to the processing container 10 to introduce a gas into the processing container 10. For example, a flow of the processing gas from the gas source 21 is controlled by the flow control unit within the IGS 22. The processing gas from the gas source 21 is heated as it flows through the external pipe 23, flows into the gas introduction pipe 24, and then, is supplied from the gas introduction pipe 24 to the processing container 10 via the injector 14. The injector 14 functions as a gas inlet of the processing container 10.

Near the gas inlet of the processing container 10, a joint 82 for a gas pipe connected to the gas introduction pipe 24 is installed. A temperature sensor 80 is configured to penetrate the joint 82. The temperature sensor 80 is configured to measure the temperature of the gas in the gas introduction pipe 24. The temperature sensor 80 transmits the measured temperature to the control device 121. In addition, a second heater 81 is disposed in the gas introduction pipe 24, and the second heater 81 is configured to heat the gas in the gas introduction pipe 24.

The exhaust port 30 includes an exhaust unit 31, an exhaust pipe 32, and a pressure controller 33. The exhaust unit 31 is a vacuum pump, such as a dry pump or a turbomolecular pump. The pressure controller 33 is installed to the exhaust pipe 32 and adjusts conductance of the exhaust pipe 32 to control a pressure within the processing container 10. The pressure controller 33 is, for example, an automatic pressure control valve.

The heating unit 40 includes an insulator 41, a first heater 42, and an outer cover 43. The insulator 41 has an approximately cylindrical shape and is provided around a periphery of the outer tube 12. The insulator 41 is formed of silica and alumina as main components. The first heater 42 is linear and is installed around an inner circumference of the insulator 41 in a spiral or meandering manner. The first heater 42 is divided into a plurality of zones in a height direction of the processing container 10 and configured to perform temperature control therefor. The outer cover 43 is provided to cover an outer circumference of the insulator 41. The outer cover 43 reinforces the insulator 41 while maintaining the shape of the insulator 41. The outer cover 43 is formed of a metal, such as stainless steel. In addition, a water-cooling jacket (not illustrated) may be installed on an outer circumference of the outer cover 43 to suppress a thermal influence of the heating element 40 to the outside. The heating unit 40 heats the processing container 10 with heat generated by the first heater 42.

The cooling unit 50 supplies a cooling fluid to the processing container 10 to cool the semiconductor wafer W in the processing container 10. The cooling fluid may be, for example, the air. The cooling unit 50 supplies the cooling fluid to the processing container 10 when rapidly cooling the semiconductor wafer W, for example, after heat treatment. The cooling unit 50 includes a fluid channel 51, ejection holes 52, a distribution channel 53, a flow regulator 54, and an arrangement port 55.

A plurality of fluid channels 51 are formed in the height direction between the insulator 41 and the outer cover 43. The fluid channels 51 are, for example, channels formed on an outside of the insulator 41 in a circumferential direction thereof. The ejection hole 52 penetrates through the insulator 41 from each fluid channel 51 and ejects the cooling fluid into a space between the outer tube 12 and the insulator 41. The distribution channel 53 is installed outside the outer cover 43 and is configured to distribute and supply the cooling fluid to each fluid channel 51. The flow regulator 54 is installed to the distribution channels 53 and regulates the flow of the cooling fluid supplied to the fluid channel 51.

The arrangement port 55 is provided above a plurality of the ejection holes 52 and discharges the cooling fluid supplied to the space between the outer tube 12 and the insulator 41 to the outside of the processing container 10. The cooling fluid discharged to the outside of the processing container 10 is cooled, for example, by a heat exchanger, and is supplied back to the distribution channel 53. However, the cooling fluid discharged to the outside of the processing container 10 may be discharged without being reused. A temperature sensor 60 detects a temperature within the processing container 10. The temperature sensor 60 is installed, for example, within the inner tube 11. However, the temperature sensor 60 may be installed in any location where the temperature within the processing container 10 may be detected, for example, in a space between the inner tube 11 and the outer tube 12. The temperature sensor 60 includes a plurality of temperature measurement portions installed at different positions in the height direction, for example, corresponding to the plurality of zones. The plurality of temperature measurement portions may be, for example, thermocouples, or temperature measurement resistors. The temperature sensor 60 transmits temperatures detected by the plurality of temperature measurement portions to the control device 121.

The control device 121 controls an operation of the vertical-type heat treatment apparatus 120, thereby controlling a semiconductor process performed in the vertical-type heat treatment apparatus 120. The control device 121 may be, for example, a computer.

### <Computer>

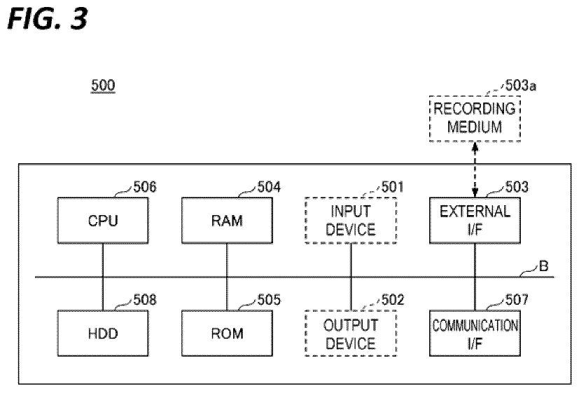

The host device 110, the control device 121, the optimization device 140, and the server device 150 included in the substrate processing system 100 illustrated in FIG. 1 are implemented by a computer with a hardware configuration, for example, as illustrated in FIG. 3. FIG. 3 is a block diagram illustrating a hardware configuration of a computer in the present embodiment of the present disclosure.

As illustrated in FIG. 3, a computer 500 of the present embodiment includes an input device 501, an output device 502, an external I/F (interface) 503, a random access memory (RAM) 504, a read only memory (ROM) 505, a central processing unit (CPU) 506, a communication I/F 507, and a hard disk drive (HDD) 508, each of which is connected by a bus B. The input device 501 and the output device 502 may be connected and used as needed.

The input device 501 is a keyboard, a mouse, or a touch panel and is used to input each operational signal by an operator. The output device 502 is a display and displays a result of processing by the computer 500. The communication I/F 507 is an interface that connects the computer 500 to the network. The HDD 508 is an example of a non-volatile storage device that stores programs or data.

The external I/F 503 is an interface to an external device. The computer 500 may perform reading and/or recording on a recording medium 503a, such as a secure digital (SD) memory card, via the external I/F 503. The ROM 505 is an example of a non-volatile semiconductor memory (storage device) in which programs or data are stored. The RAM 504 is an example of a volatile semiconductor memory (storage device) that temporarily holds programs and/or data.

The CPU 506 is a computing device that reads programs or data from the storage device such as the ROM 505 or the HDD 508 and performs a processing to implement control or functions of the entire computer 500.

### <Functional Configuration>

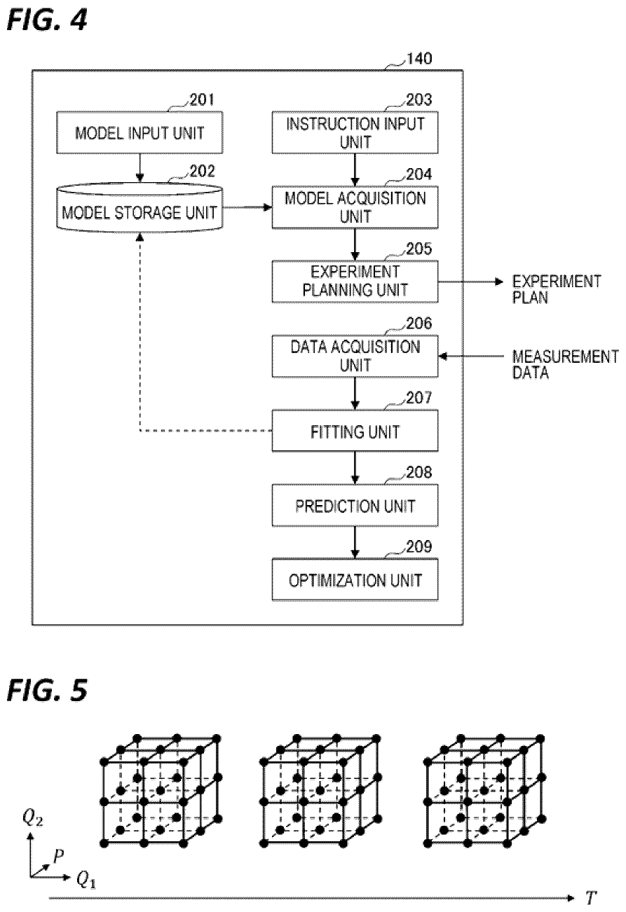

The functional configuration of the optimization device in the present embodiment will be described with reference to FIG. 4. FIG. 4 is a block diagram illustrating the functional configuration of the optimization device in the present embodiment.

As illustrated in FIG. 4, the optimization device 140 includes a model input unit 201, a model storage unit 202, an instruction input unit 203, a model acquisition unit 204, an experiment planning unit 205, a data acquisition unit 206, a fitting unit 207, a prediction unit 208, and an optimization unit 209.

The model input unit 201, the instruction input unit 203, the model acquisition unit 204, the experiment planning unit 205, the data acquisition unit 206, the fitting unit 207, the prediction unit 208, and the optimization unit 209 are implemented by, for example, the CPU 506 illustrated in FIG. 3 executing a program loaded on the RAM 504.

The model storage unit 202 is implemented by, for example, the RAM 504 or the HDD 508 illustrated in FIG. 3.

The model input unit 201 accepts an input of a model equation. The model input unit 201 may accept an input of a plurality of model equations. The model input unit 201 stores the accepted one or more model equations in the model storage unit 202.

The model equation may be a mathematical model that expresses a physical phenomenon. The physical phenomenon may include a physical phenomenon related to a process, which is performed by the substrate processing apparatus 120. The physical phenomenon related to a process is a physical phenomenon that may occur during the execution of the process. The physical phenomenon related to the process may also be a physical phenomenon that affects a process result. The physical phenomenon may include, for example, a chemical reaction, a gas phase reaction, or a surface reaction that occurs in the processing container 10 of the substrate processing apparatus 120.

The model equation may be, for example, a mathematical model related to a reaction rate of chemical vapor deposition (CVD) according to the Arrhenius equation. Equation 1 is an example of the mathematical model related to the reaction rate.

$$DR = {α ( {Q}^{β} \frac{P}{T} )}^{n} {e}^{- \frac{γ}{T}} \qquad ( 1 )$$

In Equation 1, DR is a reaction rate, Q is a supply gas flow rate, T is a reaction surface temperature, P is the pressure within the processing container, and α, β, n, and γ are adjustable parameters.

The model equation may be, for example, a mathematical model related to resistivity. Equation 2 is an example of the mathematical model related to resistivity.

$$ρ = ( {ρ}_{0} + {α}_{1} {N}_{1} + {α}_{2} {N}_{2} + ⋯ ) ( 1 + \frac{β}{d} ) \qquad ( 2 )$$

In Equation 2, ρ₀ is electrical resistivity in solid (bulk), α is a coefficient, N is an impurity concentration in crystals, β is the reflectance of electrons at an interface, and d is a film thickness. When the reflectance β is zero, it indicates perfect reflection. When the reflectance β is greater than zero, it indicates the occurrence of diffused reflection.

The model equations indicated in Equation 1 and Equation 2 are only examples and are not limited thereto. For the model equations, any mathematical model may be used, which expresses a physical phenomenon related to the process result by the substrate processing apparatus 120.

The model storage unit 202 stores a model group including a plurality of model equations. The model group stored in the model storage unit 202 includes a model equation accepted by the model input unit 201.

The instruction input unit 203 accepts an input of instruction information indicating an optimization target. The instruction information may include information indicating the substrate processing apparatus 120, information indicating the process, and information indicating an object variable. The instruction information may include a plurality of object variables. Each piece of information included in the instruction information may be designated by a user.

The object variable may be a physical quantity indicating a process result obtained by the substrate processing apparatus 120. The physical quantity indicating the process result may be a physical quantity that may be measured by the substrate processing apparatus 120 during execution of the process. The physical quantity indicating the process result may be a physical quantity that may be measured from the processing target that has been processed. The physical quantity indicating the process result may include a film formation amount (a film formation rate and in-plane uniformity), electrical characteristics (resistivity, a dielectric constant, a coercive electric field, and residual polarization), an etching rate (wet etching rate (WER) and dry etching rate (DER)), optical constants (a refractive index and an attenuation rate), coverage, and a film composition.

The model acquisition unit 204 acquires a model equation from the model storage unit 202, based on the instruction information input to the instruction input unit 203. For example, the model acquisition unit 204 reads out a model equation corresponding to the object variable indicated in the instruction information from the model storage unit 202. When a plurality of object variables are indicated in the instruction information, the model acquisition unit 204 acquires a model equation corresponding to each of the plurality of object variables.

The experiment planning unit 205 generates an experiment plan based on the model equation acquired by the model acquisition unit 204. The experiment planning unit 205 may generate an experiment plan based on an experiment planning method, for example. For example, the experiment planning unit 205 may generate a plurality of values for each factor at a predetermined number of levels, with each variable included in each model equation as a factor, and combine these values, thereby generating an experiment plan.

The experiment planning unit 205 may select a variable to be a target of the experiment plan, based on its contribution rate to the process result. The variable to be the target of the experiment plan may be selected by user designation. For example, the experiment planning unit 205 may set a fixed value for a variable having a low contribution rate to the process result (e.g., having a small impact on the process result). By setting some of the variables as fixed values, it is possible to reduce the number of experimental conditions to be included in the experiment plan.

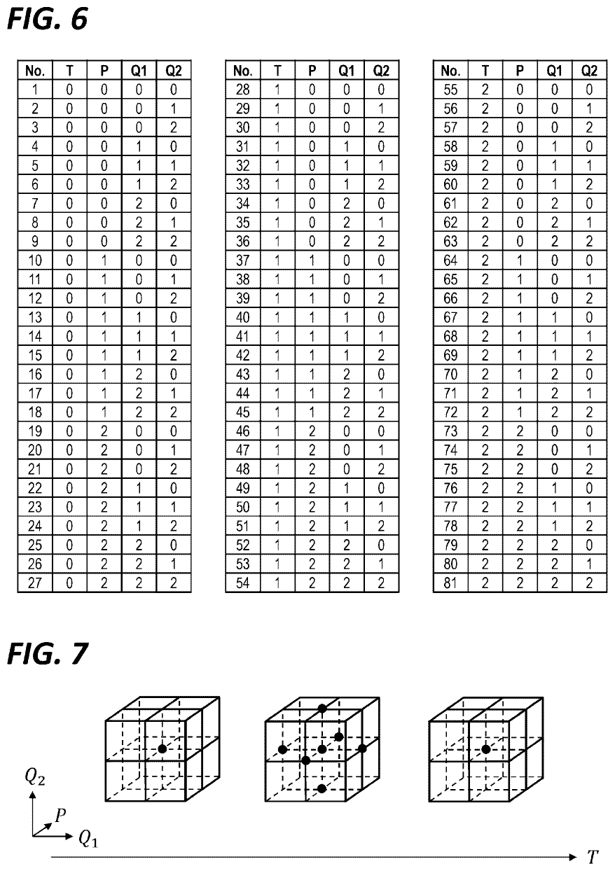

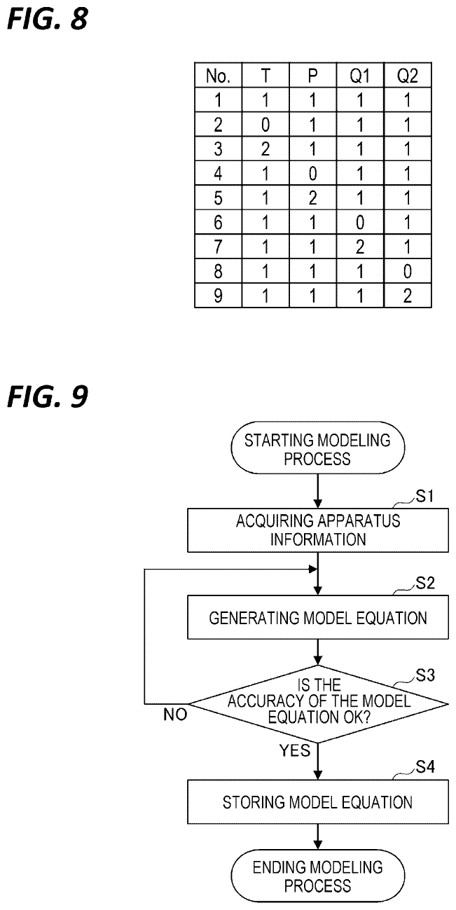

The experiment plan in the present embodiment will be described with reference to FIGS. 5 to 8. FIGS. 5 and 6 are diagrams illustrating an example of an experiment plan according to the conventional art. FIGS. 7 and 8 are diagrams illustrating an example of an experiment plan according to embodiments of the present disclosure.

Here, as an example, the generating of the experiment plan based on the model equation represented by Equation 3 is considered. Equation 3 is an example of a mathematical model related to a reaction rate of chemical vapor deposition.

$$k = α {( \frac{{Q}_{1}}{{Q}_{1} + {Q}_{2}} P )}^{n} {e}^{- \frac{β}{T}} \qquad ( 3 )$$

In Equation 3, k is a reaction rate coefficient, Q₁ is an inflow amount of reactant gas, Q₂ is an inflow amount of gas not contributing to the reaction, P is the pressure within the processing container, T is a reaction surface temperature, and α, n, and β are adjustable parameters.

The variable K in Equation 3 is a reaction rate coefficient, and a film thickness may be calculated according to Equation 4.

$$thickness = kt + C \qquad ( 4 )$$

In Equation 4, thickness is a film thickness, t is a reaction time, and C is the effect of incubation time.

Since the four factors Q₁, Q₂, P, and Tin Equation 3 are strongly nonlinear, each factor is changed to have a value at three levels. In the conventional art, overall combinations of the four factors at three levels are required to learn a regression model including interactions. FIG. 5 illustrates that the overall combinations of values of the respective factors Q₁, Q₂, P, and T are used as experimental conditions. FIG. 6 illustrates the combinations of the values of the respective factors Q₁, Q₂, P, and T that are experimental conditions in the conventional art. In FIG. 5, a cube indicates a design space, and black dots indicate experimental conditions included in the experiment plan. As illustrated in FIGS. 5 and 6, the experimental conditions required in the conventional art are 3⁴(=81).

Meanwhile, in the present embodiment, in addition to center conditions, it is sufficient to set values at two levels for Q₁, at two levels for Q₂, at two levels for P, and at two levels for T. FIG. 7 illustrates experimental conditions that are included in the experiment plan in the present embodiment. FIG. 8 illustrates the combinations of the values of the factors Q₁, Q₂, P, and T that are experimental conditions in the present embodiment. In FIG. 7, similar to FIG. 5, a cube indicates a design space, and black dots indicate experimental conditions included in the experiment plan. As illustrated in FIGS. 7 and 8, the experimental conditions required in the present embodiment are 2m+1 (=9), where m is a factor number (=4). Comparing FIG. 5 with FIG. 6, or comparing FIG. 7 with FIG. 8, it may be confirmed that the experimental conditions are significantly reduced in the present embodiment than in the conventional art.

The data acquisition unit 206 acquires measurement data indicating the process result by the substrate processing apparatus 120. The measurement data is data measured using the substrate processing apparatus 120 according to the experiment plan generated by the experiment planning unit 205. The data acquisition unit 206 may acquire measurement data input by a user. The data acquisition unit 206 may acquire measurement data from log information accumulated in the substrate processing apparatus 120.

The measurement data may be measured by an experiment using the substrate processing apparatus 120. The measurement data may be data measured by various sensors mounted on the substrate processing apparatus 120. The measurement data may be data obtained by measuring the processing target that has been processed by the substrate processing apparatus 120, using various measuring devices.

The fitting unit 207 fits parameters of the model equation acquired by the model acquisition unit 204, based on the measurement data acquired by the data acquisition unit 206. When a plurality of model equations are acquired by the model acquisition unit 204, the fitting unit 207 fits parameters for each of the plurality of model equations.

The fitting unit 207 may fit each of the parameters included in the model equations individually. The fitting unit 207 may fit a plurality of parameters in an integrated manner. For example, in the model equation illustrated in Equation 3, T may be fitted individually. In addition, (Q₁/Q₁+Q₂*P) may be fitted in an integrated manner by separating adjustment knobs. Also, since a is a simple coefficient, it may be ignored when a correlation is targeted, and may be independently adjusted.

The prediction unit 208 predicts the object variable indicated in the instruction information, based on the model equation where parameters fitted by the fitting unit 207 are set. The prediction unit 208 acquires a plurality of process conditions, which are a prediction target, and predicts the object variable for each of the plurality of process conditions, based on the model equation. The prediction unit 208 may acquire the process conditions designated by a user as a prediction target. The prediction unit 208 may randomly generate process conditions, which are a prediction target.

The optimization unit 209 optimizes the process conditions of the process indicated in the instruction information, based on a predictive value of the object variable by the prediction unit 208. The optimization unit 209 may optimize the process conditions, based on an optimization method such as the Newton method or an evolutionary algorithm, for example. These optimization methods are only an example, and any optimization method may be used.

For example, the optimization unit 209 specifies process conditions under which a predictive value satisfying a predetermined target condition has been obtained, among predictive values of the object variables. The predetermined target condition may be a condition under which an optimal process result is obtained or may be a condition where the process result is improved than that in existing process conditions. When the plurality of object variables are indicated in the instruction information, the optimal process result may be determined by arbitrary criterion, and may be determined by considering the balance of the predictive values of each object variable.

The optimization unit 209 presents an optimization result to a user. The optimization result may include predictive values satisfying a predetermined target condition and process conditions corresponding to the predictive values. The optimization result may include all predictive values predicted by the prediction unit 208 and all process conditions corresponding to the predictive values.

### <Process Sequence>

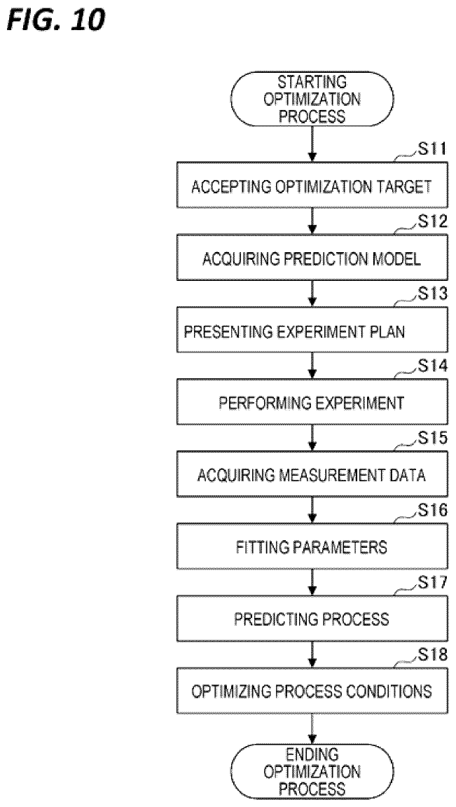

An optimization method, which is executed by the substrate processing system 100 in the present embodiment, will be described with reference to FIGS. 9 and 10. The optimization method in the present embodiment includes a modeling process (see FIG. 9) and an optimization process (see FIG. 10).

### <Modeling Process>

FIG. 9 is a flowchart illustrating a modeling process. The modeling process is a process of generating a model equation included in a model group.

In step S1, a user of the substrate processing system 100 acquires apparatus information regarding the substrate processing apparatus 120. For example, the user may acquire the apparatus information by investigating setting information or log information of the substrate processing apparatus 120.

The apparatus information includes information regarding the substrate processing apparatus 120 and information regarding the process, which is executed by the substrate processing apparatus 120. The information regarding the substrate processing apparatus 120 may include, for example, a type, a kind, and an apparatus configuration of the substrate processing apparatus 120. The information regarding the process may include, for example, a type of a process and process conditions.

In step S2, the user generates a model equation based on the apparatus information acquired in step S1. The user may generate a plurality of model equations. For example, the user may specify one or more physical phenomena that affect the process result, based on the relationship between the apparatus configuration of the substrate processing apparatus 120 and the process, and may generate a model equation expressing each of the specified physical phenomena. In the generating of the model equation, for example, known physical laws may be used. In the generating of the model equation, for example, preconditions related to the substrate processing apparatus or the process may be assumed.

As an example, the model equation for the reaction rate of chemical vapor deposition illustrated in Equation 3 will be described. Generally, in the substrate processing apparatus 120, a volume of the processing container 10 is fixed. It may be assumed that the supply gas is supplied at a constant flow rate. Meanwhile, the pressure and temperature within the processing container 10 may be adjusted. Also, the type or amount of dilution gas may be adjusted. In this case, when the film formation rate is an object variable, the user may generate model equation 3 related to the reaction rate according to the Arrhenius equation.

In step S3, the user checks the accuracy of the model equation generated in step S2. For example, the user calculates an error between an actual measurement value of the process result measured by the substrate processing apparatus 120 and the predictive value of the process result predicted based on the model equation, for various process conditions. When the error between the actual measurement value and the predictive value is within a threshold value, the user may determine that the accuracy of the model equation is sufficient. Meanwhile, when the error between the actual measurement value and the predictive value exceeds the threshold value, the user may determine that the accuracy of the model equation is insufficient.

When the accuracy of the model equation is sufficient (YES), the process proceeds to step S4 by the user. Meanwhile, when the accuracy of the model equation is insufficient (NO), the user returns the process to step S2. After returning to step S2, the user reconsiders the model equation. For example, the user may reconsider the assumed preconditions, adjust the fixed parameters, or change the physical law on which the model equation is based.

In step S4, the user inputs the model equation generated in step S2 to the optimization device 140. In the optimization device 140, the model input unit 201 accepts the input of the model equation. The model input unit 201 stores the accepted model equation in the model storage unit 202.

### <Optimization Process>

FIG. 10 is a flowchart illustrating an optimization process. The optimization process is a process for optimizing process conditions based on the model equation generated in the modeling process.

In step S11, the instruction input unit 203 of the optimization device 140 accepts the input of instruction information indicating the optimization target. The instruction input unit 203 sends the input instruction information to the model acquisition unit 204.

The instruction input unit 203 may accept the input of the instruction information, in response to the user's manipulation on an optimization support tool. The optimization support tool is an example of a tool that is provided to the user of the substrate processing system 100, in order to optimize the process conditions. The optimization support tool may be executed by the optimization device 140. The optimization support tool may be executed by another information processing apparatus that may communicate with the optimization device 140 via a communication network.

In step S12, the model acquisition unit 204 of the optimization device 140 receives instruction information from the instruction input unit 203. Next, the model acquisition unit 204 reads out a model equation corresponding to an object variable indicated in the received instruction information, from the model storage unit 202. Then, the model acquisition unit 204 sends the read model equation to the experiment planning unit 205 and the fitting unit 207.

In step S13, the experiment planning unit 205 of the optimization device 140 receives the model equation from the model acquisition unit 204. Next, the experiment planning unit 205 generates an experiment plan based on the received model equation. Then, the experiment planning unit 205 presents the generated experiment plan to the user. For example, the experiment planning unit 205 displays the experiment plan on the optimization support tool.

In step S14, the user performs an experiment using the substrate processing apparatus 120 according to the presented experiment plan. This generates measurement data indicating the process result by the substrate processing apparatus 120.

In step S15, the data acquisition unit 206 of the optimization device 140 acquires the measurement data generated in step S14. Next, the data acquisition unit 206 sends the acquired measurement data to the fitting unit 207.

In step S16, the fitting unit 207 of the optimization device 140 receives the model equation from the model acquisition unit 204. Also, the fitting unit 207 receives the measurement data from the data acquisition unit 206. Next, the fitting unit 207 fits the parameters of the model equation based on the measurement data. Continuously, the fitting unit 207 sets the fitted parameters in the model equation. Then, the fitting unit 207 sends the model equation where the fitted parameters are set, to the prediction unit 208.

The fitting unit 207 may store the model equation where the fitted parameters are set in the model storage unit 202. The fitting unit 207 may store only the fitted parameters in the model storage unit 202, in association with the model equation. By storing the fitted parameters, when instruction information indicating the same optimization target is input, steps S13 to S16 may be omitted.

In step S17, the prediction unit 208 of the optimization device 140 receives the model equation where the fitted parameters are set, from the fitting unit 207. Then, the prediction unit 208 acquires a plurality of process conditions, which are a prediction target. Continuously, the prediction unit 208 predicts an object variable for each of the plurality of process conditions, based on the acquired model equation. The prediction unit 208 sends a predictive value of the object variable to the optimization unit 209.

In step S18, the optimization unit 209 of the optimization device 140 receives the predictive values of the object variables from the prediction unit 208. The optimization unit 209 optimizes process conditions, based on the received predictive value of the object variable. For example, the optimization unit 209 specifies a predictive value satisfying a predetermined target condition, among predictive values of the object variables.

Continuously, the optimization unit 209 presents an optimization result to the user. For example, the optimization unit 209 displays the optimization result on the optimization support tool.

The user may use the presented optimization result in process development. In addition, the user may set process conditions indicated in the presented optimization result in the substrate processing apparatus 120 and perform a process according to the process conditions in the substrate processing apparatus 120. The substrate processing apparatus 120 performs a process on a substrate according to optimized process conditions. Accordingly, the user may obtain a good process result.

### <User Interface>

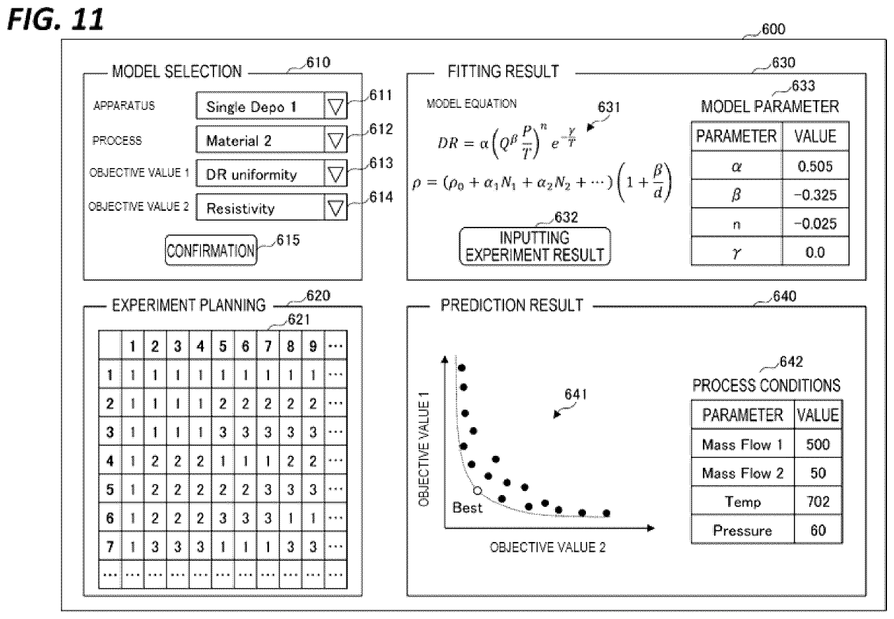

A user interface of the substrate processing system 100 in the present embodiment will be described with reference to FIG. 11. FIG. 11 is a diagram illustrating an optimization support tool.

As illustrated in FIG. 11, an optimization support tool 600 includes a model selection area 610, an experiment plan area 620, a fitting result area 630, and an optimization result area 640.

The model selection area 610 includes an apparatus selection section 611, a process selection section 612, objective value selection sections 613 and 614, and a confirmation button 615. Although two objective value selection sections 613 and 614 are illustrated in FIG. 11, the number of the objective value selection sections may be arbitrarily set, or may be increased or decreased by a user's manipulation.

A selection of the substrate processing apparatus 120, which may be an optimization target, is displayed on the apparatus selection section 611. A selection of a process (to be performed in the substrate processing apparatus 120), which is selected from the apparatus selection section 611, is displayed on the process selection section 612. A selection of object variables associated with the process selected from the process selection section 612 is displayed on the objective value selection sections 613 and 614.

When the user selects the apparatus selection section 611, the process selection section 612, and the objective value selection selections 613 and 614 and then, presses the confirmation button 615, instruction information including information selected from each selection section is input to the optimization device 140.

The experiment plan area 620 displays an experiment plan 621 generated by the optimization device 140. The user may perform an experiment on the substrate processing apparatus 120 according to the experiment plan 621 displayed in the experiment plan area 620.

The fitting result area 630 includes a model equation display section 631, a result input button 632, and a parameter display section 633.

The model equation display section 631 displays a model equation acquired by the optimization device 140. The model equation displayed in the model equation display section 631 is a model equation corresponding to an object variable selected from the objective value selection sections 613 and 614.

When the user presses the result input button 632, a screen for inputting measurement data obtained from the experiment starts up. The screen for inputting the measurement data may be an input screen including an input section for inputting an actual measurement value of each object variable for each experimental condition, or may be a selection screen including a selection section for selecting electronic data in which the measurement data is recorded. When the user inputs the measurement data on the started screen, the measurement data is input to the optimization device 140.

The parameter display section 633 displays parameters of the model equation fitted by the optimization device 140. The user may verify validity of parameters displayed on the parameter display section 633.

The optimization result area 640 includes a prediction result display section 641 and a process condition display section 642.

The prediction result display section 641 displays a predictive value included in an optimization result by the optimization device 140. The prediction result display section 641 may display predictive values for all process conditions, which are prediction targets. The prediction result display section 641 may emphasize and display predictive values that satisfy a predetermined target condition. The prediction result display section 641 illustrated in FIG. 11 displays process conditions with optimal predictive values as a white circle, and displays predictive values for the other process conditions as black circles.

The process condition display section 642 displays process conditions included in the optimization result by the optimization device 140. The process condition display section 642 may display the process conditions under which a predictive value satisfying a predetermined target condition has been obtained. The process condition display section 642 may display the process conditions corresponding to the predictive value selected from the prediction result display section 641 by the user.

### <Prediction Accuracy>

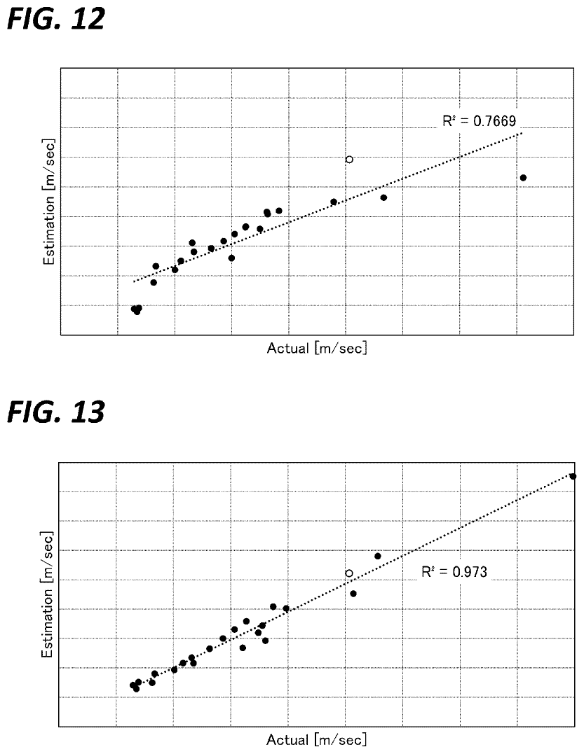

The prediction accuracy by the optimization device 140 in the present embodiment will be described with reference to FIGS. 12 and 13. FIG. 12 is a diagram illustrating prediction accuracy according to the conventional art. FIG. 13 is a diagram illustrating prediction accuracy according to an embodiment of the present disclosure.

FIG. 12 is a graph illustrating prediction accuracy of a reaction rate by polynomial multiple regression. The polynomial multiple regression is performed by Lasso regression. The graph illustrated in FIG. 12 plots each process condition with a horizontal axis representing an actual measurement value (Actual) and a vertical axis representing a predictive value (Estimation). The plot of the white circle in the graph indicates process conditions with strong interactions.

As illustrated in FIG. 12, the prediction accuracy of the reaction rate by the polynomial multiple regression had a determination coefficient R² of 0.7669. It may be confirmed that, under process conditions with strong interactions, the prediction accuracy is not high due to a distance from an approximation curve.

FIG. 13 is a graph illustrating prediction accuracy of the reaction rate according to the model equation illustrated in Equation 1. As illustrated in FIG. 13, the prediction accuracy of the reaction rate according to the model equation had a determination coefficient R² of 0.973, which is higher than the prediction accuracy according to the polynomial multiple regression. It may be confirmed that, even under process conditions with strong interactions, the prediction accuracy is high due to closeness to the approximation curve.

According to FIGS. 12 and 13, it is illustrated that the prediction accuracy of the process result is improved compared to a conventional case.

### Effects of Embodiments

The optimization device 140 in the present embodiment fits parameters of a mathematical model corresponding to a process result by the substrate processing apparatus 120 based on measurement data indicating the process result measured using the substrate processing apparatus 120, and predicts a process result based on the mathematical model where the fitted parameters are set. By fitting the mathematical model corresponding to the process result, a model with high accuracy may be generated. According to the present embodiment, the process result may be predicted with high accuracy.

The mathematical model may include a model equation expressing a physical phenomenon related to the process executed by the substrate processing apparatus 120. According to the present embodiment, validity of the model equation is guaranteed, and a model with high robustness may be generated. Also, according to the present embodiment, when the substrate processing apparatus 120 includes intrinsic parameters, the parameters of the model equation are fitted so as to conform to the laws of physics, so that physically meaningful parameters may be obtained.

The optimization device 140 may generate an experiment plan based on the mathematical model, and obtain measurement data obtained by measuring a process result according to the experiment plan. The optimization device 140 may generate an experiment plan based on the contribution rate of each variable of the mathematical model. According to the present embodiment, a model may be generated through a small number of experiments, so that the process result may be predicted efficiently.

The optimization device 140 may output the process conditions of the substrate processing apparatus 120 based on the predictive value of the process result. The optimization device 140 may output the process conditions under which a predictive value satisfying a predetermined target condition has been obtained. According to the present embodiment, the process conditions may be optimized efficiently with high accuracy. According to the present embodiment, even without experts, the process conditions may be easily optimized.

In addition, the mathematical model may be a model equation that may be solved algebraically. It takes a large amount of time to search for process conditions by numerical analysis. However, by using a model equation that may be solved algebraically, a calculation speed for parameter fitting or process prediction increases.

Furthermore, when the mathematical model includes a differential equation with no solution, a machine learning model such as a neural network may be utilized. Therefore, according to the present embodiment, the extensive use of the model equation is possible, and the model equation may also be used to deal with physical phenomena that may be solved only by numerical analysis.

According to the present embodiment, the number of experiments required to optimize process conditions for each substrate processing apparatus may be significantly reduced. For example, when using a model equation in which fitted parameters are set, the number of experiments required to optimize process conditions is 2m+1, where m is the number of adjustable parameters. When using a model equation requiring parameter fitting, the number of experiments required to optimize process conditions is 3m+1. In addition, when constructing a regression model from scratch, the number of experiments required to optimize process conditions is 3m. Therefore, according to the present embodiment, as adjustable parameters are increased, the number of experiments required to optimize process conditions is reduced.

### [Supplement]

The substrate processing apparatus for executing a process including a substrate processing method of the present disclosure is not limited to a heat treatment apparatus. The substrate processing apparatus may be applied to any type of apparatuses, such as an atomic layer deposition (ALD) apparatus, a capacitively-coupled plasma (CCP) apparatus, an inductively-coupled plasma (ICP) apparatus, a radial line slot antenna (RLSA) apparatus, an electron cyclotron resonance plasma (ECR) apparatus, and a helicon wave plasma (HWP) apparatus.

In addition, the substrate processing apparatus of the present disclosure may be applied to any of an apparatus using plasma and an apparatus without using plasma, as long as the substrate processing apparatus is an apparatus that performs a predetermined processing (e.g., a film formation processing or an etching processing) on the substrate. Furthermore, the substrate processing apparatus of the present disclosure may be applied to any of a single-substrate processing apparatus that processes substrates one by one, a batch apparatus that processes a plurality of substrates at once, and a semi-batch apparatus that processes, at once, a smaller number of substrates than the number of substrates processed by the batch apparatus.

In one aspect of the present disclosure, the process results may be predicted with high accuracy.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An information processing apparatus comprising:
model acquisition circuitry configured to acquire a mathematical model corresponding to a process result obtained by a substrate processing apparatus;
data acquisition circuitry configured to acquire measurement data indicating the process result measured using the substrate processing apparatus;
fitting circuitry configured to fit a parameter of the mathematical model based on the measurement data; and
prediction circuitry configured to predict the process result based on the mathematical model with the parameter fitted by the fitting circuitry.

2. The information processing apparatus according to claim 1, wherein the mathematical model includes a model equation expressing a physical phenomenon related to a process executed by the substrate processing apparatus.

3. The information processing apparatus according to claim 1, further comprising:
experiment planning circuitry configured to generate an experiment plan based on the mathematical model,
wherein the data acquisition circuitry is configured to acquire the measurement data obtained by measuring the process result according to the experiment plan.

4. The information processing apparatus according to claim 3, wherein the experiment planning circuitry is configured to select the process result for generating the experiment plan based on a contribution rate of each variable of the mathematical model.

5. The information processing apparatus according to claim 1, further comprising:
optimization circuitry configured to output a process condition for the substrate processing apparatus based on a predictive value of the process result.

6. The information processing apparatus according to claim 5, wherein the optimization circuitry is configured to output the process condition under which the predictive value satisfying a predetermined target condition has been obtained.

7. An information processing method comprising:
acquiring a mathematical model corresponding to a process result obtained by a substrate processing apparatus,
acquiring measurement data indicating the process result measured using the substrate processing apparatus,
fitting a parameter of the mathematical model based on the measurement data, and
predicting the process result based on the mathematical model with the parameter fitted in the fitting.

8. A non-transitory computer-readable storage medium having stored therein a program that causes an information processing apparatus to execute a process including:
acquiring a mathematical model corresponding to a process result obtained by a substrate processing apparatus,
acquiring measurement data indicating the process result measured using the substrate processing apparatus,
fitting a parameter of the mathematical model based on the measurement data, and
predicting the process result based on the mathematical model with the parameter fitted in the fitting.
